(19) United States
(12) Patent Application Publication
(10) Pub. No.: US 2020/0349529 A1
(43) Pub. Date: Nov. 5, 2020

(54) AUTOMATICALLY PROCESSING TICKETS

(71) Applicant: WeWork Companies LLC, New York, NY (US)

(72) Inventors: Haixun Wang, Palo Alto, CA (US); Shengqi Yang, Palo Alto, CA (US); Manender Verma, Palo Alto, CA (US)

(21) Appl. No.: 16/863,891

(22) Filed: Apr. 30, 2020

Related U.S. Application Data
(60) Provisional application No. 62/841,177, filed on Apr. 30, 2019.

(51) Int. Cl. G06Q 10/00; G06F 40/284

(52) U.S. Cl. CPC G06Q 10/20; G06F 40/284

(57) ABSTRACT

A system receives multiple support tickets, each of which contains support request text and is generated based on a support request received from a user of a computer system communicatively coupled to the system. The system applies a trained model to the support request text of each support ticket to assign a label to each support ticket. The label designates a type of support request contained in the support request text. The system renders a dashboard displaying a representation of the multiple support tickets organized according to the assigned labels.

### CROSS-REFERENCE TO RELATED APPLICATION

This application claims the benefit of U.S. Provisional Patent Application No. 62/841,177, filed Apr. 30, 2019, which is incorporated herein by reference in its entirety.

### BACKGROUND

Support ticket tracking systems help businesses to receive, track, and resolve customer requests and concerns. As examples, a customer who rents space in an officesharing environment may submit requests for assistance to such a system to report that an office space is too cold; a wireless network is not functioning; a printer has become jammed; or an additional chair is needed. Such requests may be submitted by filling out a web form, for example, or sending an email message to a particular address.

Typically, the system creates a “ticket” for each request it receives. A created ticket waits in a group of pending tickets until it can be reviewed and acted on by a person whose job responsibilities include doing so. If that person succeeds in resolving the request to which a ticket corresponds, they mark the ticket as resolved, and the system removes it from the queue.

In some cases, a person may review and update a ticket, such as by categorizing the ticket, adding missing information to the ticket, or selecting a particular person or group of people who should address the ticket. This process is sometimes referred to as “ticket triage.”

Such systems typically report on pending tickets and resolve tickets in various ways.

### BRIEF DESCRIPTION OF THE DRAWINGS

FIG. 1 is a block diagram showing some of the components typically incorporated in at least some of the computer systems and other devices on which the system operates.

FIG. 2 is a display diagram showing a sample display presented by the system in some embodiments to make available a main dashboard reflecting status information about received tickets.

FIG. 3 is a display diagram showing a user interface presented by the system in some embodiments to compare tickets received for different locations.

FIG. 4 is a flowchart illustrating a process performed by the system to automatically classify tickets into a taxonomy

FIG. 5A is a chart document showing the major languages used a set of sample tickets.

FIG. 5B is a chart diagram showing the frequency with which different labels were applied to tickets among a set of sample tickets.

FIG. 6 is a diagram showing the overall structure of the transformer.

FIG. 7 is an interface diagram showing the application of the transformer to digest text, such as a single sentence, to produce a class label for that text.

FIG. 8 is a model architecture diagram showing the organization of the system's model with respect to transformer.

FIG. 9 is a graph diagram showing the training loss that attends the training process.

FIG. 10 is a chart diagram showing the distribution of sentiments predicted for a sample of tickets.

FIG. 11 is a chart diagram showing the relative frequency of top keywords in one sample of tickets from the United States.

FIG. 12 is taxonomy diagram showing a sample taxonomy used by the system in some embodiments.

### DETAILED DESCRIPTION

The inventors have identified significant disadvantages of conventional support ticket tracking systems. First, manually triaging and acting on tickets as must be done in a conventional system consumes significant employee time, which is an expensive resource that could otherwise be curtailed and/or used for other valuable purposes. Similarly, the time employees spend triaging and acting on tickets uses significant computing resources because the employees spend a significant amount of time navigating through disorganized, unhelpful display screens. Second, the manual triage that is performed in accordance with most conventional systems often characterizes tickets in ambiguous ways, or even clearly incorrect ways that require further resources to correct. Third, conventional systems provide few insights into how well a customer service organization is satisfying its customers, preventing the customer service organization from being able to proactively respond to problems.

In order to address the shortcomings of conventional systems, the inventors have conceived and reduced to practice a software and/or hardware system for automatically processing support tickets (“the system”).

In some embodiments, the system provides an automated, data-driven platform that identifies problems and trends in tickets processing, increases the efficiency of building operations and customer support, and/or boosts member satisfaction. In various embodiments, the system addresses scenarios including the following:

Automatic ticket labeling. Unleash employees (“CMs”) from repetitive ticket processing tasks.

Uncover detailed ticket information, such as keywords and topics, by digging deep into the text content. This can save significant ticket triaging time.

Perceive members sentiments. Build correlations between members satisfaction and building health. This can help determine and correlate building churn rate.

Benchmark the tickets of a location by comparing to other locations. (E.g., by building, city, country, or region.) Using the comparison provided by the system, building operations can determine issues in time and rectify them, which in turn leads to a better member experience.

Some components and processes described herein are similar to those described in U.S. patent application Ser. No. 16/835,012, filed Mar. 30, 2020, and U.S. Provisional Patent Application No. 63/001,178, filed Mar. 27, 2020, which are incorporated herein by reference in their entirety.

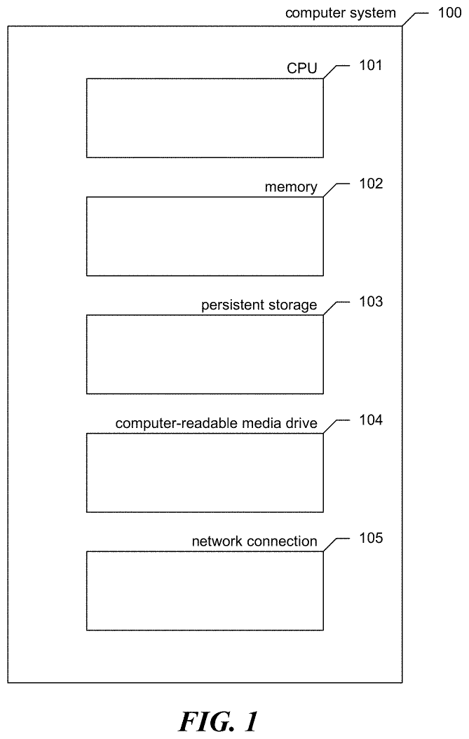

FIG. 1 is a block diagram showing some of the components typically incorporated in at least some of the computer systems and other devices on which the system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the system and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the system, those skilled in the art will appreciate that the system may be implemented using devices of various types and configurations, and having various components.

In some embodiments, the system provides a main dashboard that shows ticket labels, sentiments, keywords, and problems. In this view, it is easy to track the labels of tickets in multiple dimensions, such as locations, time ranges, and sentiments. One can further drill down a specific label to get its time series trend with the associated sentiments and top keywords/problems.

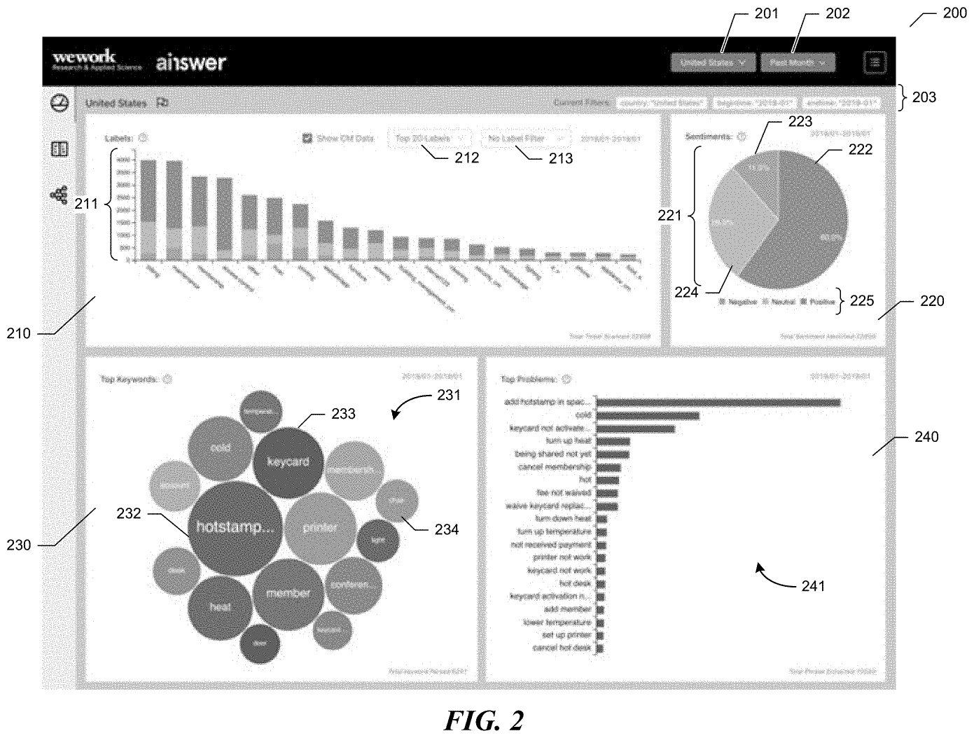

FIG. 2 is a display diagram showing a sample display presented by the system in some embodiments to make available a main dashboard reflecting status information about received tickets. In particular, the display 200 includes a geography selection control 201 and time period selection control 202 that the user may manipulate in order to select a geographic region or location and/or a time period to which to filter the received tickets. The display includes a label section 210. As shown, the label section includes a stack chart 211 showing the frequency with which different labels occur among the tickets. For example, the leftmost stack indicates that a “billing” label has been attributed to almost 4,000 tickets. It can further be seen by comparing the colors and/or patterns in this stack to sentiment key 225 that approximately 300 of the “billing” tickets express a negative sentiment, approximately 1,200 of them express a neutral sentiment, and approximately 2,400 of them express a negative sentiment. The user can select a particular label, such as by clicking on its name or stack in the stack chart, or selecting it using control 213. In response, the system replaces the display of the shown stack chart with a stack chart that shows, among only the tickets having the selected label, the number received in each of a number of different time periods. For example, if the user uses control 212 to select “the last six months,” then the resulting stack chart shows the number of “billing” tickets received in each of the last six months. Initially, these stacks contain tickets for which all sentiment categories are discerned. The user can select a particular sentiment, such as in the corresponding region of pie chart 221, or by clicking on the sentiment name or color and/or pattern in sentiment key 225. In response, the system shows in each stack of the stack chart only those tickets expressing the selected sentiment.

The display further includes a sentiment section 220 containing a pie chart 221 showing the fraction of filtered tickets expressing each of three different sentiment categories: positive sentiment category 222, neutral sentiment category 224, and negative sentiment category 223. Like stack chart 211 shown in label section 210, pie chart 221 show in sentiment section 220 is based on an aggregation across all of the tickets selected in accordance with current filters 203.

The display also contains a keyword section 230 containing word cloud 231 showing the relative frequency of different keywords extracted from the tickets selected by current filters 203. For example, can be seen in the word cloud that the keyword “hotstamp . . . ” 232 has the highest frequency, the keyword “keycard” 233 has an intermediate frequency, and the keyword “chair” 234 has a smaller frequency.

The display also includes a problem section 240, which in turn contains bar graph 241 showing the frequency of different problems related by the selected tickets. For example, it can be seen from the top bar that the most frequent problem among the selected tickets is “add hotstamp in spac . . . ”

In some embodiments, the system provides a comparison view that gives users the option to chart sentiments, labels and top keywords for one location (building/city/country/region) against another in parallel and see how they are doing in comparison to each other.

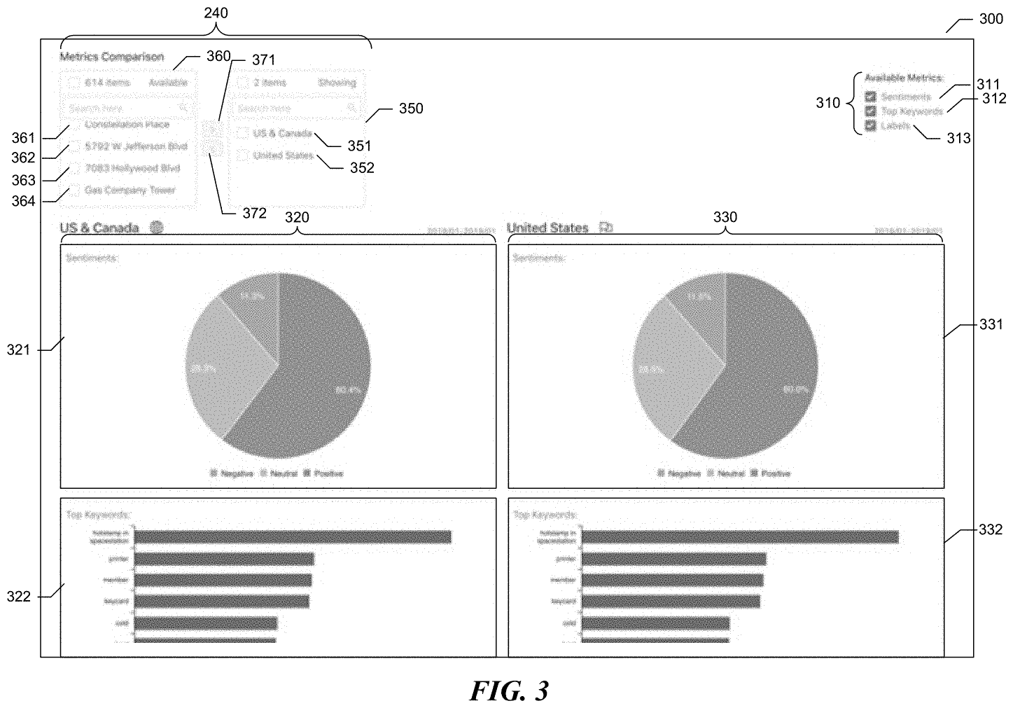

FIG. 3 is a display diagram showing a user interface presented by the system in some embodiments to compare tickets received for different locations. The display 300 includes control 310 for choosing which metrics about tickets to compare for each selected location. For example, the user can check the sentiments checkbox 311 to display sentiment area 321 for first location “US and Canada” 320, and sentiments area 331 for second location “United States.” Because “top keywords” checkbox 312 is checked, keywords areas 322 and 332 are displayed for these locations. And because labels checkbox 313 is checked, the user can scroll down from the present display to make visible labels areas for both locations that are not presently shown. Controls 340 can be manipulated by the user to specify which locations are selected for comparison. In particular, selected locations box 350 contains indications 351 and 352 that the two locations “US and Canada” and “United States” are selected for comparison. To remove one of these locations, the user can check its checkbox, then click on a deselection control 372 to remove that location from selected location box 350, and remove the corresponding column for that location from the comparison. In order to add a location to the comparison, such as one of locations 361-364, the user checks the corresponding checkbox in unselected location box 360, then activates a selection control 371. This causes the new location to be added to the selected location box 350, and a column to be added to the comparison for the new location.

In some embodiments, the system provides a taxonomy view that organizes the knowledge of tickets as a tree-like hierarchical structure. Taxonomies are sometimes used to build complex AI systems.

The dashboards described herein, shown for example with respect to FIGS. 2 and 3, create a convenient, easily understandable representation of support tickets received by the system. The dashboards aid the system or an employee of the system to quickly identify types of support tickets and monitor trends in support. The dashboards display information in a way such that a user of the dashboard does not need to individually navigate through support tickets, reducing the number of actions the user must take to reach a particular type of support ticket, The automatic labeling of support tickets performed by the system, as represented on the dashboards, also improves the system because it enables the system to organize, route, and in some cases automatically respond to the support tickets.

In some embodiments, the system leverages a set of cutting-edge machine learning (“ML”) and natural language processing (“NLP”) techniques. In the core is a large deep neural network (called the “BERT model”) trained on a large number of tickets—such as two million tickets—on processing elements such as GPU servers.

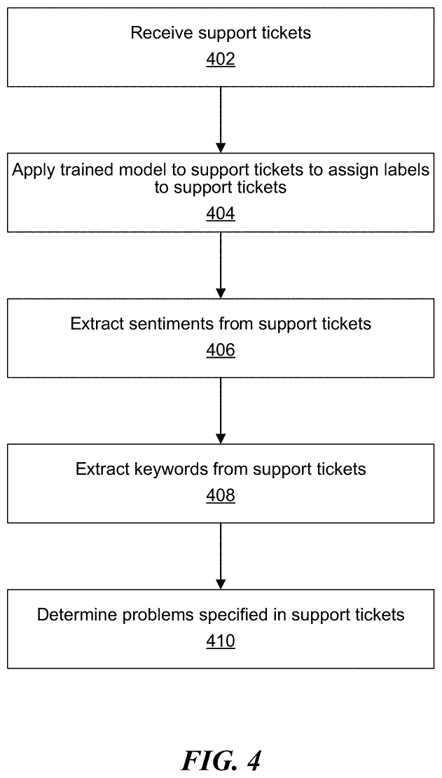

FIG. 4 is a flowchart illustrating a process performed by the system to automatically classify tickets into a taxonomy, according to some implementations.

At block 402, the system receives support tickets. Each support ticket contains support request text and is generated based on a support request received from a user of a system coupled to the system. For example, one or more systems can manage rental and maintenance of a physical space, such as an office space, and the user of the system can be a person who rents the physical space. In this example, user support requests can include, for example, requests to increase or decrease a temperature in the physical space, requests for additional furniture or supplies for the space, or requests related to billing or account management. Other example systems that can be coupled to the system include rental systems that manage rentals of products such as vehicles, tools, or sound systems; vacation rental systems; or generic computing devices in an enterprise network; and the corresponding support requests can pertain to issues such as vehicle maintenance needs, cleaning needs for a vacation home, or support for malfunctioning applications on a computing device. Numerous other example support requests and the corresponding system for submitting the support requests to the system can be contemplated by one of skill in the art.

At block 404, the system applies a trained model to support tickets to classify the support request contained in each support ticket. To classify the support requests, the system automatically assigns each ticket an appropriate label. The labels can be selected from a set of labels predefined within the taxonomy. For example, when classifying support requests pertaining to rental office spaces, the labels can include any classifications related to the rental process or the physical office space, such as “hvac” or “billing.” The classifier supports ticket classification in different languages inherently. The model applied by the system is described further below.

At block 406, the system extracts sentiments from the received support tickets. Sentiments represent moods, emotions, and/or feelings expressed in the support text of tickets from users. For example, the system performs sentiment analysis to indicate the opinions of users to building services associated with office rental space. Sentiment extraction is described further below.

At block 408, the system extracts keywords or phrases from the received support tickets. Keywords and phrases can provide a succinct representation of ticket content and help to categorize the tickets into relevant subjects in finer granularities. In addition, paraphrasing is applied to acquire knowledge about synonyms or abbreviations, such as “ac”=“air con”=“air conditioning.” Keyword extraction is described further below.

At block 410, the system determines problems in support tickets. A problem can be at least a portion of the support text, and can be selected from the support text through natural language processing techniques as being a description of the reason for the support request.

In various embodiments, the system provides some or all of the following by execution of the process shown in FIG. 4:

Automatic ticket understanding via NLP and ML.

Significant accuracy in predictions.

Transfer learning is applied to reduce need for human supervision/annotation efforts.

One model fits all: the model supports text classification tasks in 104 languages.

Based on the labels applied to the support tickets and any sentiments, keywords, or problems extracted from the text, various implementations of the system perform some or all of the following activities:

Ticket processing benchmark and trending analysis. The system automatically recognizes ticket anomalies and provides early alert/notification. In addition, correlation analysis uncovers possible relations between members tickets and building health.

Automated ticket routing. With a highly accurate classifier, tickets are in many cases tagged and routed with zero-touch from CMs. This is effective in reducing customer waiting time, and frees up CMs' bandwidth.

Automatic ticket response. It is important to provide timely response to members' request. In practice, many repetitive tickets can be automatically addressed by the system. For example, the system an automatically respond to a support ticketing requesting a temperature change to a physical space by increasing or decreasing the temperature in the space. For complex requests, the system automatically interacts with members to identify more information about their need.

Report generation. Reports, including tickets processing status and the building health, are automatically generated and sent to the required audiences (e.g., CMs, Operations, and Executives).

In some embodiments, the system incorporates a set of cutting-edge ML and NLP techniques, such as transfer learning, large-scale pretraining, automatic keywords extraction, and taxonomy construction. These techniques make the system effective quickly without extensive human-supervised efforts. The following sections describe text classification, keywords extraction, and taxonomy construction.

### Text Classification

Text classification is a foundational task in NLP. The system uses text classification in ticket labeling and sentiment analysis. In various embodiments, the text classification performed by the system operates on text in some or all of the following forms:

Short and casual text. Tickets may be expressed in casual ways in their text. It is quite difficult for a technique to accurately understand the text if it lacks a general knowledge, such as “ac”=“air con”=“air condition.” Moreover, the short nature of ticket text introduces additional difficulty compared with long and complete text which can provide rich information about an issue.

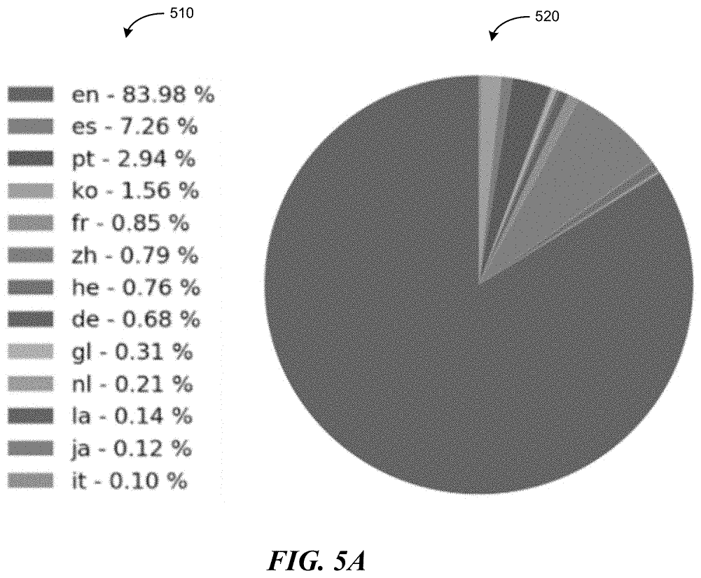

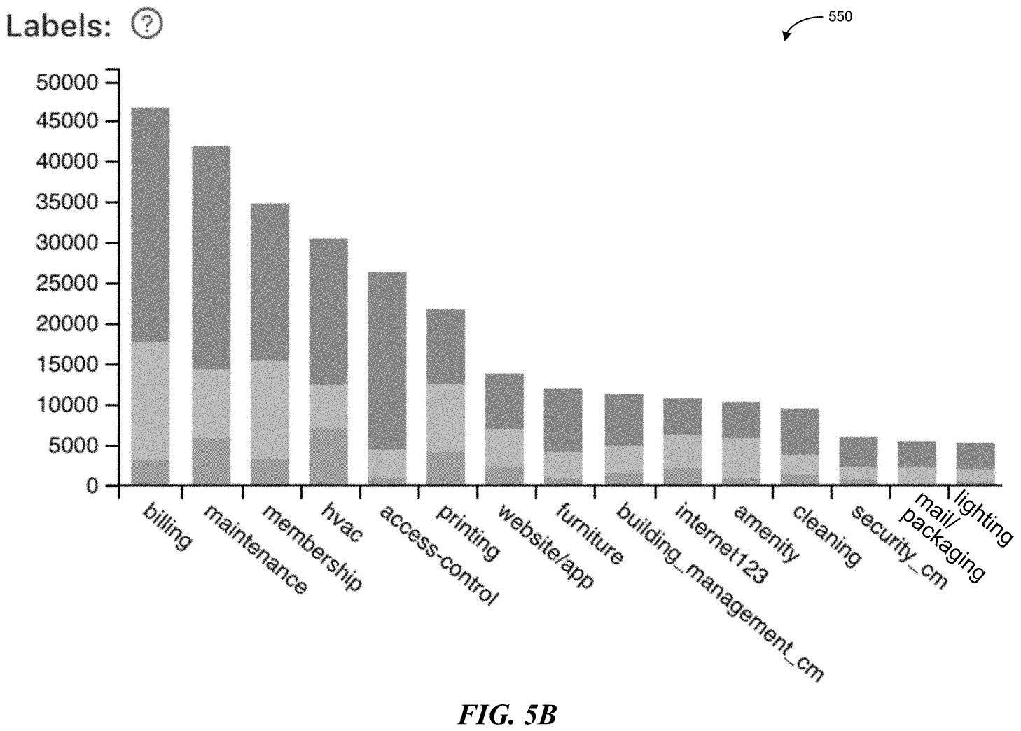

Multilingual text. As locations expand globally, it is helpful to provide localized services by classifying and processing members' service requests in their own language. FIG. 5A is a chart document showing the major languages used in the tickets used in recent sample of tickets. In particular, textual chart 510 and pie chart 520 show the distribution of languages used across the sample tickets. It can be seen from these charts that four different languages are each used in more than 1% of the tickets; eight different languages are each used in more than 0.5% of the tickets; and 13 different languages occur in at least 0.1% of the tickets.

Lack of labeled text. Many successful ML and NLP applications require that large amounts of labeled data to be available for training a model. However, in many support ticket tracking systems, there is not enough labeled data to learn from scratch.

To address the above challenges, the system employs inductive transfer learning. In some embodiments, the system's transfer learning framework includes two major steps:

Large-scale pretraining. With the nearly unlimited amount of electronic text corpora, such as in books, news, and Wikipedia, it is possible to train a universal language model (“LM”) that employs a single model to capture the facts across languages. Better still, with the burst of recent NLP research, there are also vast amounts of labeled text data available, such as labeled text data used in tasks like question answering, natural language inference, and machine translation. Collective pretraining on such supervised tasks further improves the model by learning deep discriminative features. Accordingly, the system can perform a first training cycle to pre-train the model using a corpus of textual data including text other than the support request text of the support tickets. The corpus of data used for the first training cycle can be any labeled corpus of textual data.

Task-specific fine-tuning. The model obtained from pretraining possesses both shadow and deep features from the text corpora. By transferring such knowledge, the model is adaptable to train on many downstream tasks, such as text classification, by simply fine-tuning the pretrained parameters. Usually, fine-tuning can achieve a high-performance model, with the use of very limited labeled domain data. After pre-training the model using a generic corpus of textual data, the system performs a second training cycle on the pre-trained model. The second training cycle uses labeled support request text to fine-tune the ability of the model to label new support tickets.

The benefits of using such a framework in text classification tasks are twofold. (1) Pretraining allows the model to learn universal features that are applicable to many languages. (2) Fine-tuning greatly reduces supervised efforts. With very limited labeled tickets data, the system is able to accomplish tickets classification while achieving state-of-the-art accuracy. The system's classification skill is applied for at least two major applications, i.e., ticket labeling and sentiment analysis.

### Ticket Classification

Ticket classification is understanding the content of tickets, then assigning a proper label (category), such as “hvac” or “billing”, to each ticket. This process is also known as tickets labeling, categorization, or triage. By leveraging a highly effective classifier, the system is able to automatically label thousands of tickets in seconds, compared to the hours it would take CMs to manually complete the same task. FIG. 5B is a chart diagram showing the frequency with which different labels were applied to tickets among all the tickets in the United States in 2018. In particular, the chart 500 shows that, for example, about 47,000 tickets were labeled with the “billing” label, about 42,000 tickets were labeled with the “maintenance” label, etc.

### Modeling

In some embodiments, the system's text classifier is built on the BERT described in Jacob Devlin, Ming-Wei Chang, Kenton Lee, and Kristina Toutanova. 2018. BERT: Pre-training of Deep Bidirectional Transformers for Language Understanding, available at https://arxiv.org/pdf/1810.04805.pdf, which is hereby incorporated by reference in its entirety. This text classifier uses a deep neural network model and a specific training strategy.

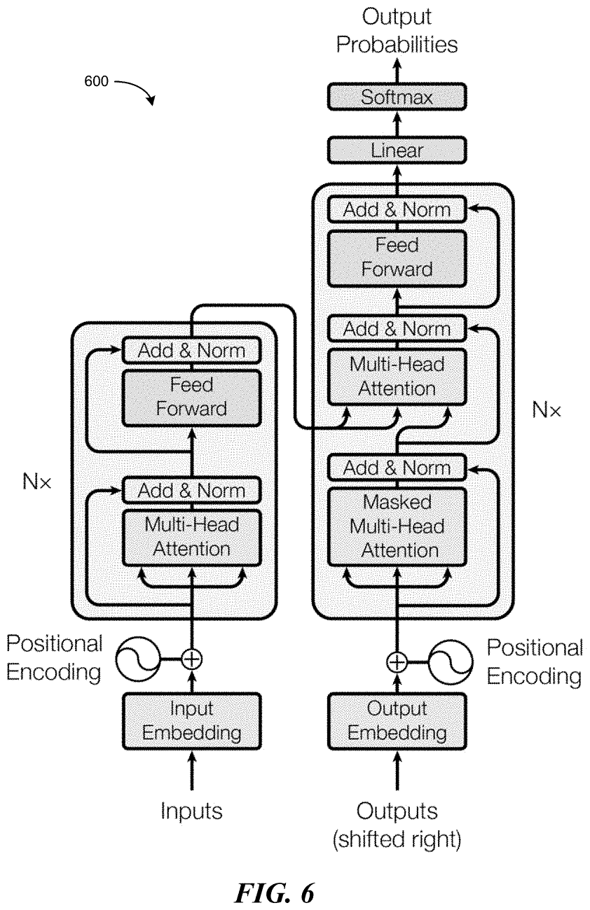

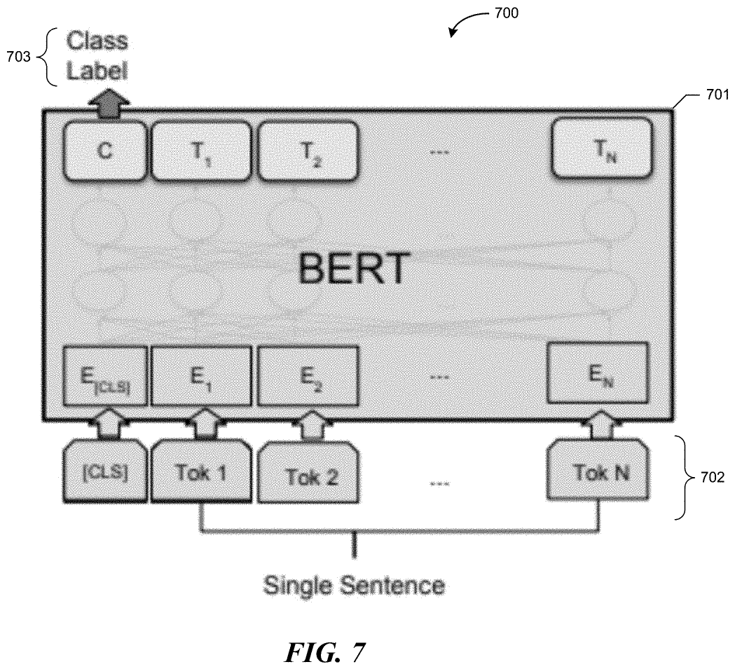

In some embodiments, the classifier uses a Transformer, a deep neural network model with attention mechanism described in Ashish Vaswani, Noam Shazeer, Niki Parmar, Jakob Uszkoreit, Lion Jones, Aidan N. Gomez, Lukasz Kaiser, and Illia Polosukhin. 2017. Attention is all you need. In NIPS, 2017, which is hereby incorporated by reference in its entirety. The Transformer model can learn contextual relations between words (or word pieces) in a text. Originally applied for machine translation, the model consists of two separate components: an encoder that reads the text input and a decoder that produces a prediction for the task, i.e., a translated text. In some embodiments, the system only uses the encoder part in its classifier. FIG. 6 is a diagram showing the overall structure of 600 of the transformer. FIG. 7 is an interface diagram showing the application of the transformer 701 to digest text 702, such as a single sentence, to produce a class label 703 for that text.

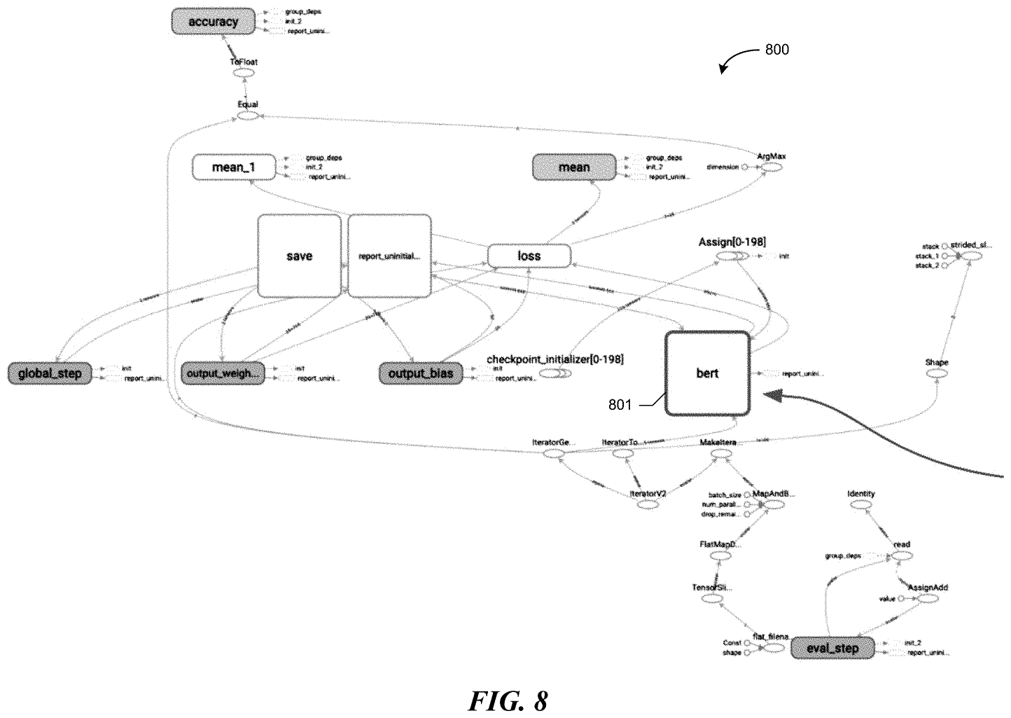

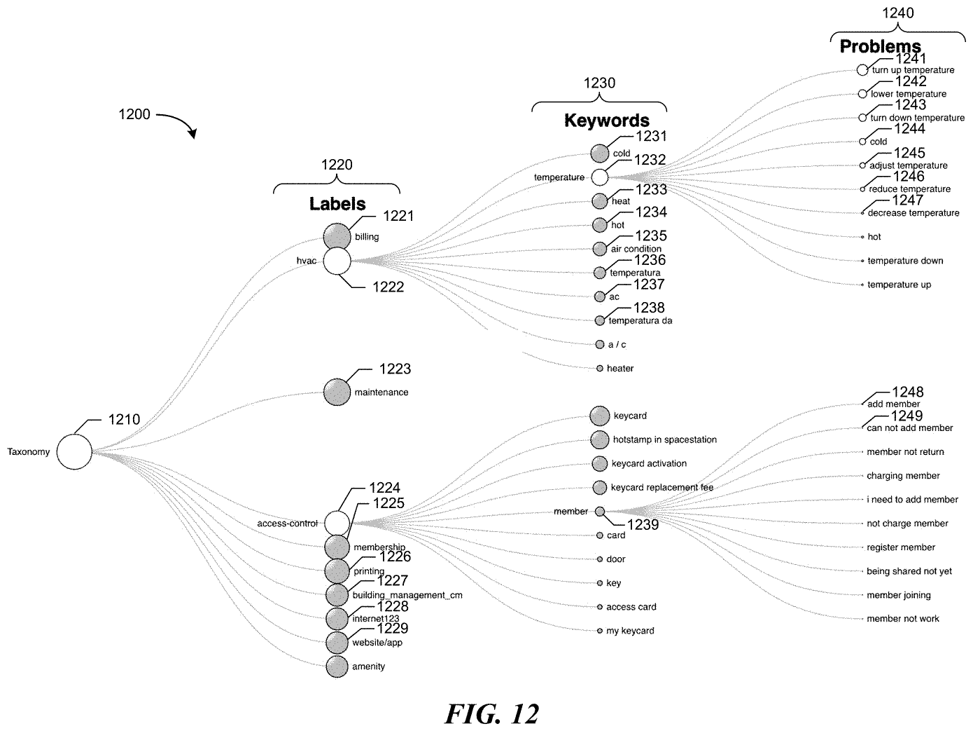

The system uses a pretrained model, such as BERT, and adds a classification layer on top of the pretrained model. FIG. 8 is a model architecture diagram showing an example organization 800 of the system's model with respect to transformer 801. In particular, in the example of FIG. 8, (1) A large pretrained BERT model is adopted as the base model. In some embodiments, its network has 12 Transformer layers with 768 hidden dimensions and 12 attention heads, resulting in 110M parameters. The base model can support 104 languages. (2) A classifier layer is added on top of the output from the base model's last layer. It has 1024 hidden dimensions in the example of FIG. 8. (3) Since the original released Adam optimizer in BERT only supports CPU and TPU, in some embodiments a version is used in the system that has been adapted to general GPU operations using parameter towers. The final classification model is shown in FIG. 12, discussed below, in which the module with a red border is the BERT text encoder having 12 layers.

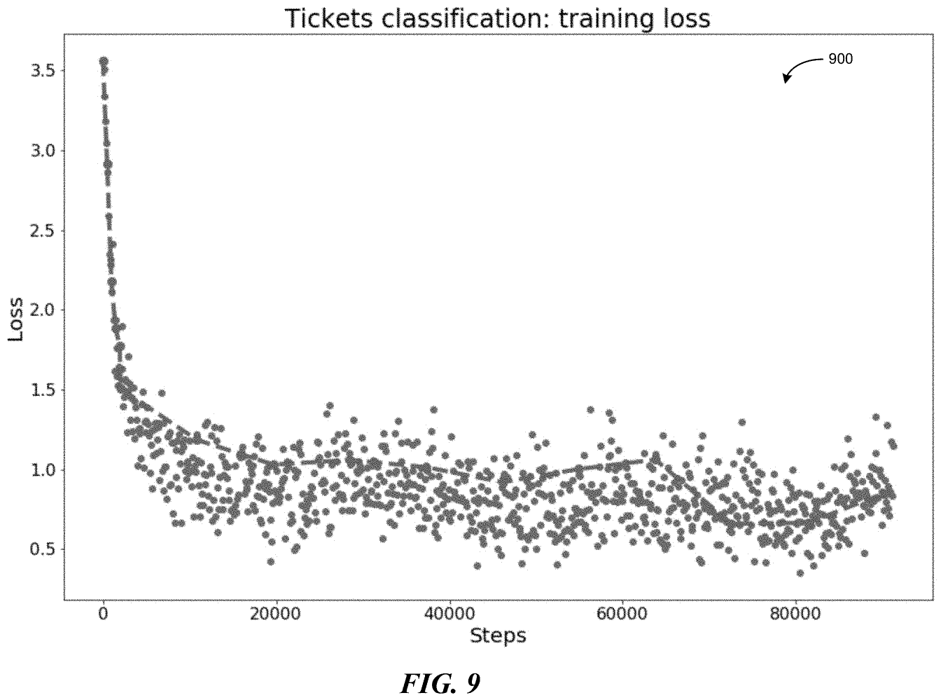

Large-scale deep neural network training on sequence data, such as sentence text, can be quite time-consuming. The system directly employs the pretrained based model and fine-tunes the classification model, such as on an AWS p3.8xlarge instance with 4 GPUs. A training on 1.78M tickets data takes 3.48 hours (on average 7.6 training steps per second), reduced from around 10 hours on a single CPU server, a 3× speed-up. FIG. 9 is a graph diagram showing the training loss 900 that attends the training process.

### Sentiment Analysis

The sentiment analysis task is to examine the tickets for understanding the members' opinions that are implicitly expressed in the text. Usually, when our members submit tickets, which are either service requests or just complains, there are typical moods, emotions, and feelings expressed in the text content. In NLP, sentiment analysis is usually performed by implementing a classification which can predict the polarity of a given text, i.e., negative, neutral, or positive. For ticket sentiment analysis, no labeled data is available for training a classifier directly. Thus, in some embodiments, the system first trains a classifier using public labeled sentiment data, such as movie reviews and twitter text, and then apply the trained classifier to predict the tickets sentiments.

The sentiment classification model is similar to the one for tickets classification. Example performance of the model when applied to several benchmark sentiment datasets is shown in Table 1.

TABLE 1
Model accuracy on sentiment tasks (public datasets)

| | | Amazon | Movie Reviews |
|---|---|---|---|
| Model | Twitter | Reviews | (SST) |
| fastText | 0.792 | 0.916 | 0.904 |
| system | 0.861 | 0.958 | 0.935 |

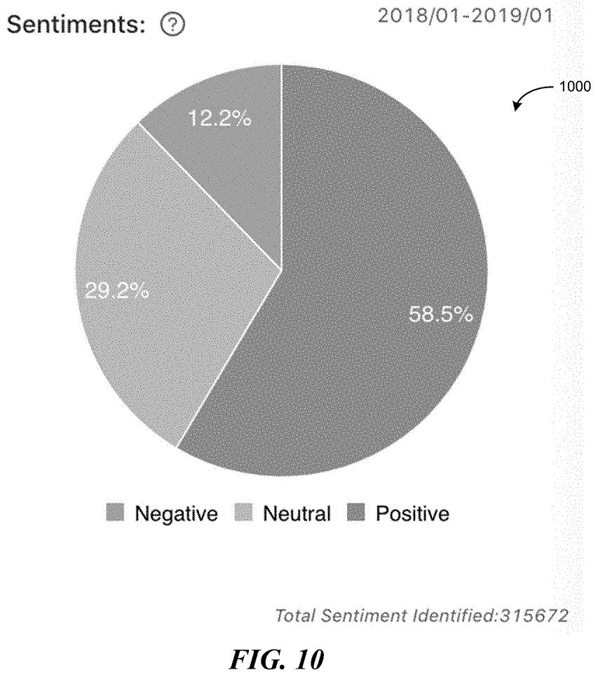

FIG. 10 is a chart diagram showing the distribution 1000 of sentiments predicted for a sample of tickets. Several example tickets are also shown in Table 2 below, together with the predicted sentiments.

TABLE 2
Example tickets with their predicted sentiments.

| Ticket | Sentiment |
|---|---|
| Hi there, I've just joined as a WeWork | Positive |
| member. Would like to inquire about | |
| hosting an event in October. | |
| Please turn the AC down a little, but not | Neutral |
| off completely. | |
| I am still trying to eliminate one of my | Negative |
| hot desks. I feel quite stupid but I can't | |
| find this anywhere within my settings. | |
| I do not want the security deposit to be | Negative |
| credited toward my next charges. It is | |
| very important that the monthly charge | |
| comes up in my bank account each month | |
| otherwise I will not be reimbursed by my | |
| company. I've mentioned this before. | |

### Keyword Extraction

In addition to the labels, keywords can provide a succinct representation of the tickets content. Therefore, keywords can help to categorize the tickets into relevant subjects in finer granularities. In order to recognize the keywords in tickets text, in some embodiments the system uses POS (part of speech) tagging, which is to assign a part-of-speech label, such as pronoun, noun, and verb, to each word in a sentence. Moreover, the extracted results are normalized such that the keywords with the same meaning, such as “ac”, “air con”, and “air condition”, are not treated as different subjects. This is also known as paraphrasing in NLP. The system applies a symbolic approach to deal with such a problem. Table 3 below shows several examples of tickets with the keywords recognized.

TABLE 3
Example tickets with extracted keywords italicized, and resulting label.

| Label | Ticket text (with keywords) |
|---|---|
| hvac | It's also feeling quite chilly in F145. Could we have the |
| | temperature brought up? |
| hvac | Hey guys [symbol] can we get our air con set at 22 Celsius, |
| | please? |
| furniture | Hi, could we get another chair for our office, please? |
| billing | Can't get to my credit card update site. It jumps to your |
| | website, and it doesn't go further. |
| membership | How can I reactivate my account that's been canceled? |

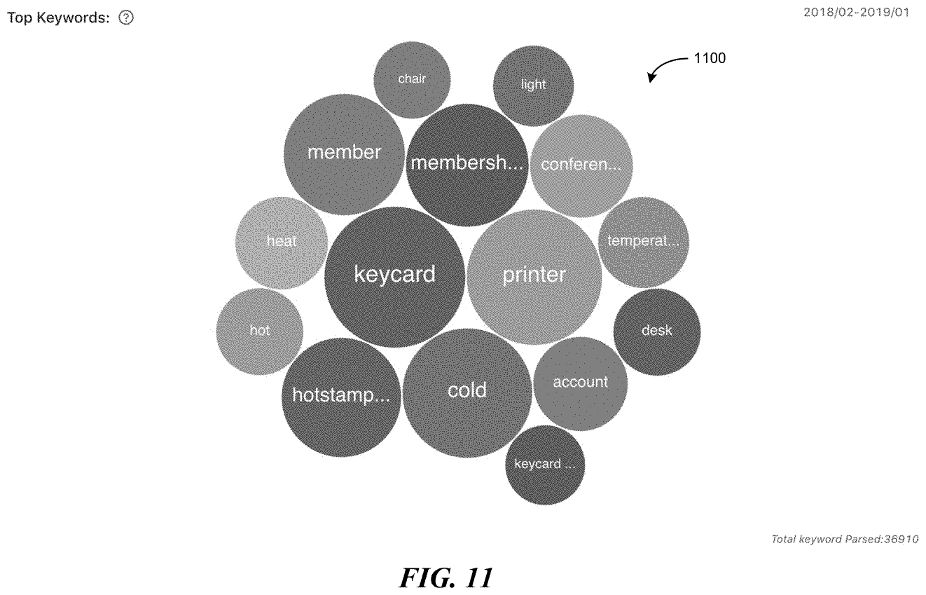

FIG. 11 is a chart diagram showing the relative frequency of top keywords in one sample of tickets from the United States. It can be seen from the chart 1100 that the keyword “printer” occurred at a greater frequency than the keyword “hot.”

### Ticket Taxonomy

The ticket taxonomy used by the system is a tree-like hierarchical structure. It organizes the knowledge of the tickets such that a machine can read a ticket and precisely understand its intents. Taxonomy construction serves as a first step in building a knowledge base that could support complex AI systems, such as tickets triage, automatic tickets replying, question answering and chatbot applications.

FIG. 12 is taxonomy diagram showing a sample taxonomy 1200 used by the system in some embodiments. The taxonomy 1200 has a head node 1210, each descendent of which is a label applied to one or more tickets, arranged in a label layer 1220. For example, these nodes are “billing” label node 1221, “hvac” billing label node 1222, a “maintenance” label node 1223, and an “access-control” label node 1224. Some of the label nodes in the label layer have children that are keyword nodes in keyword layer 1230. For example, keyword nodes 1231-1238, among other keyword nodes, are children of the “hvac” label node 1222, while “member” keyword node 1239 and other keyword nodes are children of the “access-control” label node 1224. Some keyword nodes in keyword layer 1230 are parents of problem nodes in problems layer 1240. For example, problem nodes 1241-1247 are, among other problem nodes, children of the “temperature” keyword node 1232, while problem nodes 1248-1249 and other problem nodes are children of the “member” keyword node 1239.

### Automatic Taxonomy Construction

Automatic taxonomy construction (“ATC”) is an NLP task of identifying key concepts and their relations (e.g., “is-a”) from text corpora in an automatic manner. In order to construct a ticket taxonomy, the system identifies the tickets concepts (labels, keywords, and problems) and their “is-a-problem-of” relations. For example, “temperature” 1232 is-a-keyword-of label “hvac” 1222, and “turn up temperature” 1241 is-a-problem-of “temperature” 1232, as illustrated in FIG. 12.

### Lexico-Syntactic Patterns

ATC methods build taxonomies based on “is-A” relations by first leveraging pattern-based or distributional methods to extract concept pairs and then organizing them into a tree-structured hierarchy. For example, (cat, mammal), can be extracted from sentences, such as “cat is a small mammal” and “mammal such as cat”, by applying patterns “X is a Y” and “Y such as X.” Similarly in support tickets, in order to discover “is-a-problem-of” of (X, Y), the system applies patterns such as “X not work” and “X is not working.” For example, for a ticket “[Cleaning] paper towel dispenser is not working” with a cleaning label, the system can extract (paper towel dispenser, cleaning).

### Semantic Role Labeling

The above patterns may be too specific to examine some tickets, due to idiomatic expressions, spelling errors, incomplete sentence, and ambiguity. More advanced NLP techniques, such as semantic role labeling, a.k.a., semantic parsing, are used by the system in some embodiments to process a sentence and assign labels to the words to indicate their semantic roles. A word in a ticket can be defined as Object (noun), Issue (adv+verb/verb+noun), Location, or Time. Here are some examples with role labels:

[access-control] Hi, I have a problem with the door lock (Object) in room 2019 (Location).

[furniture] Good morning, we need to hang televisions (Issue) in two of our offices (Location).

[hvac] Hi, office 4.58 (Location) ac (Object) is not working (Issue).

Conditional random fields (CRFs) are sometimes employed in semantic role labeling. In some embodiments, the system trains a CRFs model to assign roles to the words and plan to employ deep neural network approaches as the next step to further improve the accuracy.

In some embodiments, the system uses a translation-based strategy, e.g., English->Spanish, to automatically generate training data.

In some embodiments, the system recognizes patterns of tickets and suggests early alert/notification of anomalies in member service. In addition, correlation analysis is used in some embodiments to uncover possible relations between members tickets and building health (e.g., occupancy, churn rate, member growth, etc.).

In some embodiments, the system performs automatic ticket routing. With a highly accurate classifier, tickets are automatically tagged and routed with zero-touch from CMs. This can effectively reduce customer waiting time and free up CMs' bandwidth.

In some embodiments, the system performs automatic ticket response. It can be important to provide timely response to members' request. In practice, many repetitive tickets are completely addressed in an automatic manner. Example tickets are “how much does printing cost?”, “When are late fees applied”, and “How do I connect to the Wi-Fi network and what is the wifi password?” Moreover, for complex requests, the system interacts with the member via auto-response to identify more information about their need.

It will be appreciated by those skilled in the art that the above-described system may be straightforwardly adapted or extended in various ways. While the foregoing description makes reference to particular embodiments, the scope of the invention is defined solely by the claims that follow and the elements recited therein.

We claim:

1. A method comprising:
receiving at a system, multiple support tickets each containing support request text and generated based on a support request received from a user of a computer system communicatively coupled to the system;
applying, by the system, a trained model to the support request text of each support ticket to assign a label to each support ticket that designates a type of support request contained in the support request text; and
rendering by the system, a dashboard displaying a representation of the multiple support tickets organized according to the assigned labels.

2. The method of claim 1, further comprising:
performing a first training cycle, by the computer system, to pre-train the model, the first training cycle performed using a corpus of textual data including text other than support request text; and
performing a second training cycle, by the computer system, to train the pre-trained model using a corpus of support request text.

3. The method of claim 1, further comprising extracting a sentiment from the each of the received support tickets, and wherein the dashboard further displays a representation of the multiple support tickets organized according to the sentiment extracted from each support ticket.

4. The method of claim 1, further comprising:
extracting a keyword from each of the received support tickets;
wherein the dashboard further displays a representation of the multiple support tickets organized according to the extracted keywords.

5. The method of claim 4, wherein the trained model selects a label for each support ticket from a set of labels defined within a taxonomy, and wherein the keywords are associated with the labels within the taxonomy.

6. The method of claim 5, wherein the representation of the multiple support tickets comprises a representation of the taxonomy.

7. The method of claim 1, wherein the system is coupled to a system for managing rentals of physical spaces.

8. The method of claim 7, wherein the system automatically causes a change to a physical space based on the label applied to one of the support tickets.

9. A non-transitory computer readable storage medium storing executable computer program code, the computer program code when executed by a processor causing the processor to perform steps comprising:
receiving multiple support tickets each containing support request text and generated based on a support request received from a user of a computer system communicatively coupled to the system;
applying a trained model to the support request text of each support ticket to assign a label to each support ticket that designates a type of support request contained in the support request text; and
rendering a dashboard displaying a representation of the multiple support tickets organized according to the assigned labels.

10. The non-transitory computer readable storage medium of claim 9, wherein the computer program code further causes the processor to perform steps comprising:
performing a first training cycle, by the computer system, to pre-train the model, the first training cycle performed using a corpus of textual data including text other than support request text; and
performing a second training cycle, by the computer system, to train the pre-trained model using a corpus of support request text.

11. The non-transitory computer readable storage medium of claim 9, wherein the computer program code further causes the processor to perform steps comprising extracting a sentiment from the each of the received support tickets, and wherein the dashboard further displays a representation of the multiple support tickets organized according to the sentiment extracted from each support ticket.

12. The non-transitory computer readable storage medium of claim 9, wherein the computer program code further causes the processor to perform steps comprising:
extracting a keyword from each of the received support tickets;
wherein the dashboard further displays a representation of the multiple support tickets organized according to the extracted keywords.

13. The non-transitory computer readable storage medium of claim 12, wherein the trained model selects a label for each support ticket from a set of labels defined within a taxonomy, and wherein the keywords are associated with the labels within the taxonomy.

14. The non-transitory computer readable storage medium of claim 13, wherein the representation of the multiple support tickets comprises a representation of the taxonomy.

15. The non-transitory computer readable storage medium of claim 9, wherein the system is coupled to a system for managing rentals of physical spaces.

16. The non-transitory computer readable storage medium of claim 9, wherein the system automatically causes a change to a physical space based on the label applied to one of the support tickets.

17. A method in a computing system, comprising:
receiving a plurality of support requests each generated by a user and comprising support request text;
for each received support request, creating a support ticket containing the support request text;
for each of at least a portion of the created support tickets:
extracting keywords from the contained support request text;
using extracted keywords to determine a label; and
attributing the determined label to the support ticket.

18. The method of claim 17, further comprising, for each of at least a portion of the created support tickets, using the attributed label to route the support ticket.

19. The method of claim 17, further comprising, for each of at least a portion of the created support tickets, using the attributed label to perform automatic processing intended to resolve the support ticket.

20. The method of claim 17, further comprising:
using labels attributed to at least a portion of the created support tickets to generate a visual analytic; and
causing the generated visual analytic to be displayed.
